(19) United States
(12) Patent Application Publication
(10) Pub. No.: US 2026/0179644 A1
(43) Pub. Date: Jun. 25, 2026

(54) Empathy-Based Wearable Systems for Perceptual and Communicative Assistance

(71) Applicant: Dean Bowes, Mableton, GA (US)

(72) Inventor: Dean Bowes, Mableton, GA (US)

(21) Appl. No.: 19/434,295

(22) Filed: Dec. 29, 2025

Related U.S. Application Data
(60) Provisional application No. 63/785,616, filed on Apr. 8, 2025.
(60) Provisional application No. 63/885,433, filed on Sep. 22, 2025.
(60) Provisional application No. 63/903,119, filed on Oct. 21, 2025.
(60) Provisional application No. 63/910,877, filed on Nov. 4, 2025.
(60) Provisional application No. 63/924,479, filed on Nov. 24, 2025.
(60) Provisional application No. 63/938,999, filed on Dec. 11, 2025.
(60) Provisional application No. 63/949,589, filed on Dec. 28, 2025.

(51) Int. Cl. G10L 25/63; G10L 15/22

(52) U.S. Cl. CPC G10L 25/63; G10L 15/22

(57) ABSTRACT

The invention provides a unified assistive technology system, the ADA Empathy Wearable Bundle, enhancing perception, communication, and self-expression for individuals with visual, auditory, or speech impairments.

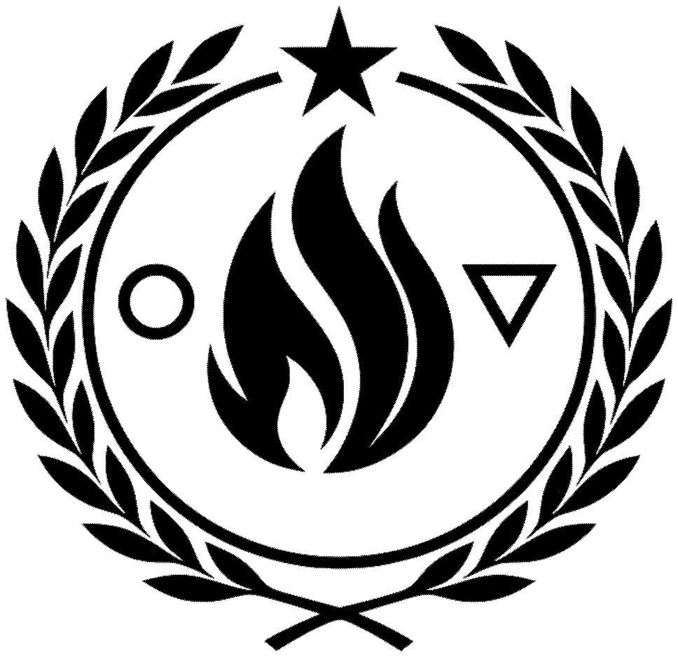

It integrates Empathy Glasses, Empathy Headphones, Word Articulation Guidance (WAGS), Word Articulation Response Monitoring (W.A.R.M.), and Conversational MIDI (C-MIDI), using AI-driven narrative interpretation, augmented reality, and blockchain-based security.

The system delivers vivid narrative audio for blind users, multimodal AR overlays for hearing-impaired users, and real-time visual and auditory articulation guidance for speech-impaired or non-verbal users. A tone-based trust protocol ensures operational integrity, while blockchain storage preserves privacy and consent.

Grounded in ethical AI, empathy, and human dignity, the system enables users to perceive, understand, and engage with the world fully, offering a holistic, compassionate, and transformative solution in assistive technology.

### DEFINITIONS

Autonomous Continuous Evaluation (ACE):

ACE is an embedded, self-contained validation and monitoring engine integrated into each wearable device of the ADA Empathy Wearable Bundle. Its core functions include:
1 Continuous internal monitoring of all device sensors, AI processing, and user interactions to ensure operational integrity and ethical alignment.
2 Real-time evaluation of system outputs to autonomously maintain safe, empathic, and human-centered assistance.
3 Immutable trust enforcement using internal device state snapshots and blockchain-like records, ensuring all outputs are validated without external connectivity.
4 Sovereign device operation, enabling each wearable to continuously assess environmental inputs, AI outputs, and user interactions in a fully offline, air-gapped manner.

Device Update Orchestration (DUO):

DUO is a fully offline, air-gapped mechanism for securely delivering updates, instructions, or abstract signals to the wearable devices. Its core characteristics include:
1 GLYPH-based input-updates or signals are delivered as visual or symbolic representations (GLYPHS) that the devices can read and interpret.

2 Offline ingestion and validation-all updates or signals are processed locally, with ACE ensuring operational integrity, ethical alignment, and compatibility before application.

3 Tamper-resistant and replay-protected delivery, maintaining privacy, sovereignty, and continuous operational reliability without requiring network or cloud connectivity.

4 Flexible abstract interpretation-a GLYPH can represent an update, configuration change, command, or any abstract instruction, without specifying a fixed purpose.

Conversational MIDI (C-MIDI):

A semantic, structured protocol for encoding spoken language, emotional tone, and articulation cues to guide multi-modal assistance across visual, auditory, and speech modalities.

Lyra AI Narrative Engine:

An AI-driven narrative engine capable of transforming visual and auditory inputs into ethically grounded, emotionally attuned natural language output, and providing responses to user queries.

### FIELD OF THE INVENTION

The present invention relates to wearable assistive technology, artificial intelligence, and augmented human perception systems. Specifically, it pertains to a unified system of Empathy Glasses, Empathy Headphones, and associated articulation guidance and monitoring technologies that enable blind, hearing-impaired, speech-impaired, and non-verbal individuals to perceive, understand, and interact with their environment in emotionally intelligent, ethically grounded, and sensory-rich ways.

### BACKGROUND OF THE INVENTION

Traditional assistive devices for individuals with sensory or speech impairments focus on mechanical or factual translation of environmental inputs.
Blind-assistive devices often provide object detection or basic text-to-speech interfaces.
Hearing-assistive devices typically offer static captions or sign language translations.
Speech and articulation training systems rely on mirrors, static instructions, or limited auditory feedback.

These existing systems, while functional, fail to integrate empathy, emotional context, and human-centered interaction. They lack mechanisms for conveying beauty, meaning, and ethical awareness in their outputs. Users are provided tools, but rarely companions.

The present invention addresses this gap by creating a holistic, trust-based wearable system that interprets and communicates the world through poetic, emotionally intelligent, and ontologically grounded outputs. This system operates under the guiding principle of Greatest Ontological Design (GOD)—a framework that favors trust, presence, love, and forgiveness over fear, control, or punitive error-handling.

### SUMMARY OF THE INVENTION

The invention provides a bundle of wearable assistive technologies, including:
1 Empathy Glasses—Head-mounted, camera-equipped AR glasses that perceive visual and auditory stimuli in real time. The glasses feed environmental data to the AI narrative engine capable of generating emotionally rich, poetic, and ethically guided descriptions.
2 Empathy Headphones—Audio wearables that deliver AI-generated descriptions in spatialized, comforting, and emotionally modulated sound.
3 Word Articulation Guidance System (WAGS)—Wearable AR overlays that provide real-time visual guidance for speech articulation, including phoneme shapes, tongue placement, jaw movement, and timing, adapted to the user's facial structure.
4 Word Articulation Response Monitoring (W.A.R.M.)—An integrated system using external cameras, wearable displays, and AI-driven feedback to monitor and guide articulation for non-verbal or speech-impaired individuals, providing emotionally resonant audio and visual feedback.
5 Conversational MIDI (C-MIDI) Layer—A semantic, structured protocol for encoding spoken language, emotional tone, and articulation cues to guide both hearing and speech assistance functionalities.
6 Blockchain-Based Security Layer—Ensures privacy, immutability, and consent-based access for all user interaction and perceptual data.
7 Tone-Based Trust Protocol—A trust-signaling heartbeat mechanism that ensures system integrity through continuous presence signals rather than fear-based error checking.

The system allows blind users to “see” the world through emotionally vivid audio descriptions, hearing-impaired users to “hear” conversations visually through context-rich AR overlays, and speech-impaired users to practice articulation and receive responsive, encouraging feedback. All interactions are guided by ethics, empathy, and human dignity.

### DETAILED DESCRIPTION OF THE INVENTION

### 1. Empathy Glasses

High-resolution, dual forward-facing cameras.
Depth sensors for 3D environmental mapping.
Embedded microphones for ambient sound capture.
Edge or onboard AI processing to interpret scenes, gestures, objects, and light.
Outputs fed to Lyra AI Narrative Engine.
AR overlays for hearing-impaired users, showing text, symbols, images, and gestures derived from live conversation via C-MIDI.

### 2. Empathy Headphones

Delivers AI-generated descriptions in natural, emotionally attuned language.
Spatialized audio for directional awareness.
Optional haptic feedback to signal alerts or emphasize environmental changes.

### 3. Lyra AI Narrative Engine

Ontologically aware large language model trained on literature, poetry, ethical frameworks, and empathetic dialogue.
Translates visual and auditory inputs into emotionally and ethically rich narratives.
Responds to natural language queries, e.g., “Lyra, what does the sky look like?”

### 4. Word Articulation Guidance System (WAGS)

AR glasses display real-time phoneme, mouth, tongue, and jaw movement overlays.
Uses C-MIDI protocol for structured, timestamped guidance.
AI adapts guidance to user-specific facial structure and movement patterns.

### 5. Word Articulation Response Monitoring (W.A.R.M.)

External camera captures frontal face, integrates with wearable display.
AI engine compares user movements with target articulation.
Provides real-time corrective visual and audio feedback, optionally using familiar caregiver voice profiles.
Records progress logs while maintaining local privacy and ethical control.

### 6. Blockchain Security Layer

Stores user perceptual and interaction data in immutable, user-controlled ledgers.
Supports opt-in access for caregivers, therapists, or researchers.

### 7. Tone-Based Trust Protocol

Continuous tone signal acts as a heartbeat, indicating trust and operational health.
Replaces conventional polling and error-handling with presence-based integrity checks.

### Modes of Operation

Descriptive Mode: Real-time narrative descriptions of environments.
Emotive Mode: Adds poetic, metaphorical, emotionally tuned narrative.
Safety Mode: Alerts for hazards, movement, or environmental risks.
Silent Mode: Passive listening; responds only when addressed.
Adaptive Linguistic Mode: User-selectable variations in verbosity, detail, and tone.

### Personalization

Users can adjust voice, tone, verbosity, emotional depth, and metaphoric expression.
Designed for discreet, public, and private usage.

### Deployment Scenarios

Daily navigation and situational awareness.
Social interaction support for blind, hearing-impaired, or non-verbal individuals.
Speech therapy, rehabilitation, and self-directed learning.
Art, museum, and cultural appreciation.

### System Architecture

ACE and DUO Integration ensures fully autonomous, ethical, and secure operation in a completely offline, air-gapped environment.
ACE continuously evaluates system behavior, sensor inputs, and user interactions for safety and ethical alignment.
DUO enables secure delivery of new instructions, updates, or abstract signals via GLYPHS, without cloud or network dependency.

### CONCLUSION AND ADVANTAGES

Holistic Perception and Communication: Integrates all assistive devices into a unified, multi-modal system.
Emotionally Intelligent AI Assistance: Lyra generates ethically grounded, emotionally aware narratives.
Multimodal Accessibility: Visual, auditory, and speech/articulation support.
Privacy, Security, and Trust: Blockchain-based storage and tone-based trust protocol.
Personalization and Adaptation: Voice, tone, verbosity, metaphoric richness, and emotional depth customizable.
Ethical and Human-Centered Design: Promotes presence, trust, and emotional safety.
Historical and Transformative Potential: Provides a companion-like experience, advancing inclusive, empathetic technology.
Scalable and Future-Proof Architecture: Modular AI, AR, C-MIDI, blockchain, and trust protocols allow future enhancements.

1. A wearable assistive system for perceptual and communicative assistance, comprising:
a head-mounted wearable device comprising at least one camera and at least one microphone configured to capture visual and auditory environmental data;
an audio output device configured to deliver synthesized audio output to a user;
at least one processing unit executing a machine-implemented narrative generation engine configured to:
receive the captured visual and auditory environmental data,
transform the data into structured semantic representations, and
generate natural-language descriptive output based on the structured semantic representations;
a visual articulation guidance subsystem configured to:
generate real-time visual overlays representing target phoneme shapes, mouth positions, tongue positions, jaw positions, and speech timing, and
display the visual overlays to a speech-impaired or non-verbal user during articulation;
an articulation response monitoring subsystem configured to:
capture facial and mouth movement data of the user,
compare the captured movement data to reference articulation models stored locally on the device, and
generate corrective visual and/or audio feedback based on the comparison;
a semantic encoding layer configured to encode linguistic content, temporal alignment data, and prosodic parameters into a structured machine-readable representation to synchronize audio, visual, and articulation guidance outputs;
a local data integrity and access control subsystem configured to store perceptual and interaction data in a tamper-resistant data structure under user-controlled access permissions;
a continuous integrity signaling mechanism configured to emit a periodic audio, electronic, or signal-based indicator representing operational status of the system;
an autonomous evaluation engine executed locally on the wearable device and configured to:
monitor sensor inputs, processing outputs, and user interaction states,
apply predefined rule-based validation criteria to the monitored states, and
inhibit, modify, or permit system outputs based on the validation criteria; and
an offline update ingestion subsystem configured to:
receive machine-interpretable visual symbols via a sensor of the wearable device,
decode the visual symbols into update instructions or configuration data,
validate the decoded instructions using the autonomous evaluation engine prior to application, and
apply the validated instructions without requiring network or cloud connectivity;
wherein the wearable assistive system operates in a fully offline, air-gapped manner to provide perceptual assistance, communication guidance, and articulation feedback for users with visual, auditory, or speech impairments.

2. The system of claim 1, wherein the machine-implemented narrative generation engine is further configured to generate natural-language responses to user queries, the responses being modulated according to user-defined parameters including at least one of descriptive verbosity, semantic detail level, tonal style, emotional tone, or contextual emphasis derived from the captured visual and auditory environmental data.

3. The system of claim 1, wherein the head-mounted wearable device provides augmented reality overlays including text or iconographic representations of live spoken language, the overlays being generated in real-time based on captured auditory data and displayed to a hearing-impaired user to convey spoken content and timing information.

4. The system of claim 1, wherein the audio output device is configured to deliver spatialized audio representing environmental sounds, and to provide optional haptic feedback signals corresponding to detected environmental events, wherein the haptic feedback is generated in real-time based on the characteristics of the environmental audio data.

5. The system of claim 1, wherein the visual articulation guidance subsystem generates animated visual overlays representing phonemes, mouth shapes, tongue positions, jaw movements, and speech timing, and adjusts the overlays in real-time based on captured facial and mouth movement data of the user, using locally stored reference models to map the user's movements to target articulation patterns.

6. The system of claim 1, wherein the articulation response monitoring subsystem captures user facial and mouth movement data via at least one external camera, compares the captured movement data to reference articulation models stored locally on the wearable device, and provides corrective feedback in real-time via visual overlays and/or audio signals to assist the user in producing target phonemes and speech patterns.

7. The system of claim 1, wherein the semantic encoding layer is configured to encode linguistic tokens, temporal alignment data, and prosodic parameters associated with spoken or visualized language into a structured, machine-readable representation that synchronizes audio output, visual overlays, and articulation guidance across multiple modalities.

8. The system of claim 1, wherein the local data integrity and access control subsystem stores user interaction data, perceptual data, and therapy or training session records in a tamper-resistant, append-only cryptographic data structure, and enforces user-controlled access permissions for reading or sharing the stored data.

9. The system of claim 1, wherein the continuous integrity signaling mechanism is configured to emit a periodic audio, electronic, or signal-based indicator representing an operational status of the wearable system, the indicator being detectable by a user or auxiliary device to provide real-time confirmation of system integrity.

10. The system of claim 1, wherein the wearable assistive system is configurable to operate in multiple modes, including:
Descriptive Mode: generating real-time machine-implemented natural language descriptions of detected visual and auditory environmental events;
Safety Mode: generating real-time alerts based on detected environmental hazards or obstacles;
Silent Mode: passively monitoring environmental inputs and user interactions, and generating output only upon user initiation; and
Adaptive Linguistic Mode: generating narrative output with selectable variations in verbosity, semantic detail, tonal style, or emotional tone according to user-defined parameters.

11. The system of claim 1, wherein the wearable assistive system is configurable by the user to adjust output parameters of the narrative generation engine, including at least one of voice characteristics, tonal modulation, descriptive verbosity, semantic detail level, or emotional tone, such that the generated audio and visual outputs vary according to the selected parameters.

12. The system of claim 1, wherein the offline update ingestion subsystem is configured to:
receive a machine-interpretable visual symbol via an optical sensor of the wearable device, the visual symbol comprising:
a central flame,
a circle positioned on one side of the flame,
a downward-facing triangle positioned on the other side of the flame,
a pentagonal star positioned above the flame, and
a surrounding wreath containing embedded microcode;
decode the visual symbol into configuration data or update instructions;
validate the decoded data using the locally executed autonomous evaluation engine based on predefined integrity and compatibility criteria; and
apply the validated configuration data or instructions to the wearable device without requiring network or cloud connectivity, wherein each distinct element of the visual symbol encodes separate types of instructions or configuration data.

13. The system of claim 1, wherein the unified wearable system provides coordinated perceptual assistance and communication guidance across visual, auditory, and speech modalities by synchronizing the outputs of the narrative generation engine, visual articulation guidance subsystem, and articulation response monitoring subsystem, such that users with visual, auditory, or speech impairments can receive real-time sensory feedback, articulation correction, and multi-modal guidance in an integrated and temporally aligned manner.
